(19) United States
(12) Patent Application Publication
(10) Pub. No.: US 2006/0128313 A1
(43) Pub. Date: Jun. 15, 2006

(54) Method of decreasing the times of measuring base stations' signal quality by a served mobile terminal

(75) Inventor: Chia-Lan Chang, Jhongshan City (TW)

Correspondence Address: BACON & THOMAS, PLLC, 625 SLATERS LANE, FOURTH FLOOR, ALEXANDRIA, VA, 22314, US

(73) Assignee: Institute For Information Industry, Taipei City (TW)

(21) Appl. No.: 11/028,566

(22) Filed: Jan. 5, 2005

(30) Foreign Application Priority Data
Dec. 10, 2004 (TW) 093138398

(51) Int. Cl. H04B 17/00; H04B 1/38

(52) U.S. Cl. 455/67.11; 455/561

(57) ABSTRACT

In a mobile communication system including at least one base station each having a mobile terminal covered therein, a method of decreasing the times of measuring signal quality of each base station by the served mobile terminal includes causing the mobile terminal to receive common broadcasted information containing data about the base station to be measured, causing the mobile terminal to establish a measurement table including at least one base station associated to at least one measurement group each having a corresponding measurement frequency, causing the mobile terminal to measure signal quality of each base station based on the measurement frequency of the associated measurement group, and adjusting the measurement group containing the base station based on the measured signal quality of each base station and a comparison therebetween.

### BACKGROUND OF THE INVENTION

1. Field of the Invention

The present invention relates to methods of decreasing the times of measuring base stations' signal quality and, more particularly, to a method of decreasing the times of measuring base stations' signal quality by a served mobile terminal.

2. Description of Related Art

Energy saving is a critical issue for telecommunications. Unfortunately, the operating time of a mobile communication device still cannot be prolonged to a desired period of time under existing energy saving technology. Thus, how to decrease power consumption per unit time in operating a mobile communication device is very important. In use, a mobile terminal (e.g., cellular telephone) is adapted to automatically connect to a base station having a stronger communication signal (i.e., better signal quality). The base station currently available to the mobile terminal will broadcast information including a table containing base stations to be measured by the mobile terminal. Thereafter, the mobile terminal measures all these base stations by means of polling in which signal quality of each base station is the measurement target. Further, both the polling and thus base station change will continue.

However, it is possible that some of these base stations may have a poor signal quality almost all the time during the measurement. For example, when the mobile terminal is moving far from these base stations, the signal quality might be worst. Thus, such continuing signal quality polling (i.e., measurement) not only consumes too much precious energy but also wastes the processing time of the CPU. Hence, a need for improvement exists.

### SUMMARY OF THE INVENTION

An object of the present invention is, in a mobile communication system including at least one base station each having a mobile terminal covered therein, to provide a method of decreasing the times of measuring signal quality of each base station by the served mobile terminal comprising the steps of (a) causing the mobile terminal to receive common broadcasted information containing data about the at least one base station to be measured; (b) causing the mobile terminal to establish a measurement table including at least one base station wherein the at least one base station is divided into at least one measurement group each having a corresponding measurement frequency; (c) causing the mobile terminal to measure the signal quality of each one of the at least one base station based on the measurement frequency of the associated measurement group; and (d) adjusting the measurement group containing the at least one base station based on the measured signal quality of each one of the at least one base station and a comparison therebetween. By utilizing the present invention, the times of measuring signal quality of each base station can be decreased appropriately by dynamically adjusting the measurement frequency, and thus energy can be saved.

Wherein, the signal quality of the present invention is to add a weight to the measured signal strength, the signal-to-noise ratio, or the bit error rate of the at least one base station measured by the mobile terminal, the weight being determined by considering a load of the base stations in the mobile communication system, a distance between two adjacent base stations, etc prior to being sent to the mobile terminal.

One aspect of the present invention is to enable the mobile terminal to dynamically adjust the measurement frequency of each base station based on a distance between itself and the measured base station, whether the mobile terminal is moving, or the like.

Other objects, advantages, and novel features of the invention will become more apparent from the detailed description when taken in conjunction with the accompanying drawings.

### BRIEF DESCRIPTION OF THE DRAWINGS

FIG. 1 illustrates a mobile communication system capable of carrying out a method of decreasing the times of measuring base stations' signal quality by served mobile terminals according to the invention;

FIG. 2 is a flow chart illustrating a process of decreasing the times of measuring base stations' signal quality by served mobile terminals according to the invention; and

FIGS. 3, 4, and 5 schematically depict time intervals during measurements conducted according to first, second, and third preferred embodiments of the invention respectively.

### DETAILED DESCRIPTION OF THE PREFERRED EMBODIMENT

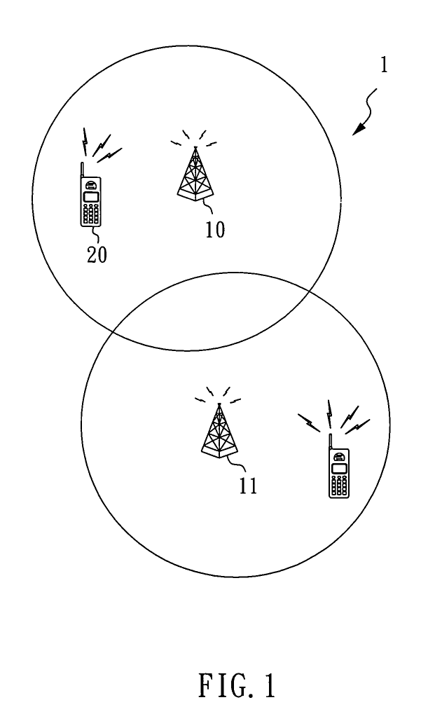

With reference to FIG. 1, there is shown a mobile communication system 1 operating in accordance with the invention. The communication system 1 comprises two base stations 10 and 11 each adapted to serve a plurality of mobile terminals within its effective communication range. For example, a mobile terminal 20 is located in the effective communication range of the base station 10. Also, the mobile terminal 20 measures the signal quality of the base station 10 and signal quality of any adjacent base stations (e.g., the base station 11).

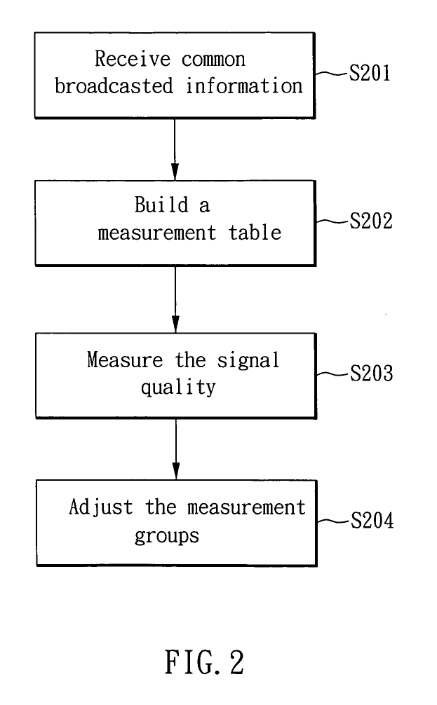

With reference to FIG. 2, a measuring process of the invention comprises receiving common broadcasted information (step S201), adding a measurement table (step S202), measuring the signal quality of the base station (step S203), and adjusting the measurement groups (step S204). In detail, the mobile terminal 20 served by the base station 10 is adapted to receive common information broadcasted by the base station 10. Such information contains data about the base stations 10 and 11 to be measured (step S201). After receiving the common broadcasted information, the mobile terminal 20 accesses information about the base stations 10 and 11 therefrom and adds the same to an embedded measurement table. For example, add the base stations 10 and 11 to be measured to the measurement table, delete one of the base stations 10 and 11 from the measurement table, or even replace all base stations with the base stations 10 and 11 to be measured. At least one of measurement group is contained in the measurement table such that the base stations 10 and 11 are adapted to be added to the selected at least one of measurement group. Each measurement group has its specific measurement frequency f. Further, the number of base stations to be measured is not limited by each measurement group (step S202).

In step S203 (i.e., measuring the signal quality of the base station), the mobile terminal 20 measures the signal quality of each one of the base stations 10 and 11 based on the measurement frequency f of a measurement group containing the base stations 10 and 11. Finally, in step S204 (i.e., the measurement group adjustment), the measurement group containing the base stations 10 and 11 are adjusted based on measured signal qualities of the base stations 10 and 11. Further, the measurement frequency f of a specific measurement group is adapted to be adjusted based on the signal quality. Alternatively, the measurement frequency f is kept the same (step S204).

The above measurement group adjustment step involves sorting the base stations 10 and 11 in the measurement table based on signal quality thereof. Next, grouping is performed based on the sorting. For example, first N1 base stations are assigned as a first group, next N1+1 to N1+N2 base stations are assigned as a second group, etc.

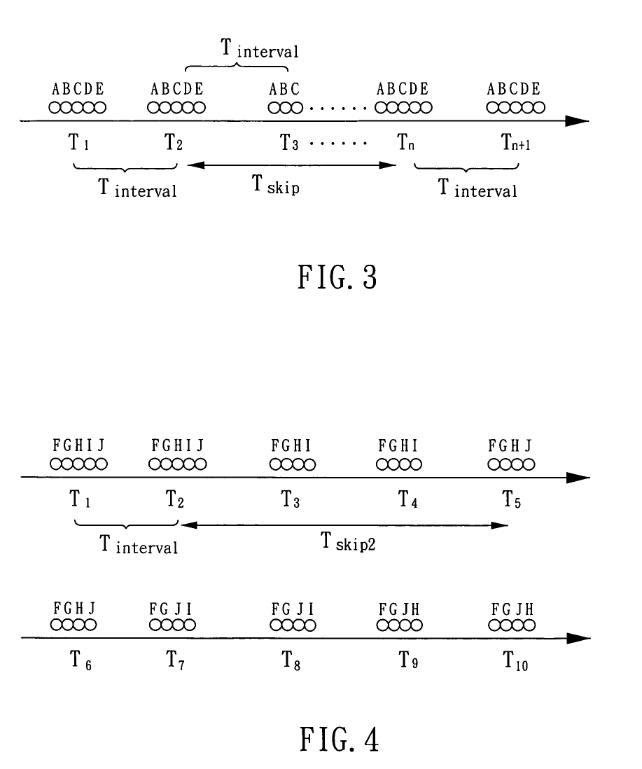

With reference to FIG. 3, time intervals during a measurement conducted according to a first preferred embodiment of the invention are illustrated. As shown, the signal quality of each of base stations A, B, C, D, and E is measured at time points T₁ and T₂ respectively. A time interval (e.g., Tᵢₙₜₑᵣᵥₐₗ) between time points T₁ and T₂ is an inverse of the measurement frequency f, and time points T_{1 and T}₂ are two consecutive effective measurements. Further, base stations A, B, and C having good signal qualities are assigned as a first measurement group with its measurement frequency being kept the same (i.e., f). To the contrary, base stations D and E having poor signal quality (e.g., due to long distance or blockage by buildings) are assigned as a second measurement group with its measurement frequency set as fₛ in which measurement frequency fₛ is an inverse of time interval Tₛₖᵢₚ and is smaller than the normal measurement frequency f. As such, base stations D and E are skipped during the time interval Tₛₖᵢₚ before time interval Tᵢₙₜₑᵣᵥₐₗ in the measurement. As an end, energy is saved in the skipped time interval.

With reference to FIG. 4, time intervals during a measurement conducted according to a second preferred embodiment of the invention are illustrated. As shown, base stations F, C, and H measured at time points T₁ and T₂ respectively are ones having good signal quality such that they are assigned as a first measurement group with its measurement frequency being kept the same (i.e., f). To the contrary, base stations I and J having poor signal qualities are assigned as a second measurement group with its measurement frequency set as fₛ₂. Also, base stations I and J are measured at a lower measurement frequency fₛ₂ in alternation in which the lower measurement frequency fₛ₂ is an inverse of time interval Tₛₖᵢₚ₂. The measurement will continue until time has reached a time point T₇. At time point T₇, the signal quality of the base station J has been found to be better than the measured signal quality of base station H. Note that the signal quality of the base station J may be weighted. As such, base station H in the first measurement group is replaced by base station J at and after time point T₇. Also, the measurement is further conducted at a measurement frequency f at and after time point T₇. The base station H is re-assigned to the second measurement group and base stations H and I are measured at a lower measurement frequency fₛ₂ in alternation.

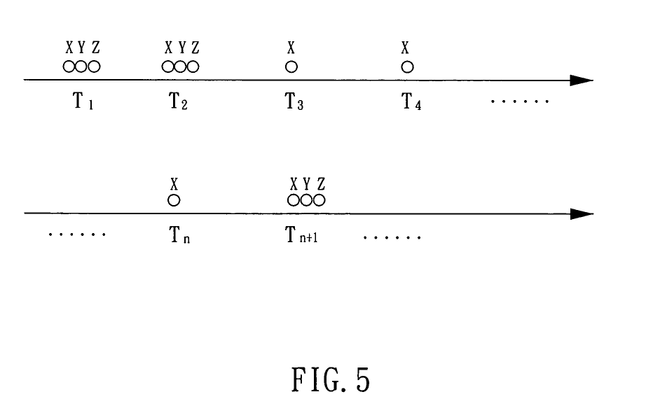

With reference to FIG. 5, time intervals during a measurement conducted according to a third preferred embodiment of the invention are illustrated. As shown, the signal quality of a base station X with the mobile terminal 20 covered therein is substantially unchanged because the mobile terminal 20 is not moving. A difference between signal qualities of the base station X measured at time point T₁ and that of the base station X measured at time point T₂ is calculated. It can be determined that the mobile terminal 20 is not moving if the difference is less than a predetermined valve (e.g., variation less than 5% of the signal quality of base station X). Thus, only the signal quality of the base station X is measured at and after time point T₃. Also, the measurement frequency fₛ₃ of the measurement group containing base stations Y and Z is set as a predetermined value (e.g., infinite). Thus, base stations Y and Z are skipped in the measurement until the time has reached a time interval Tₙ₊₁ where the signal quality variation has been found to be larger than the predetermined value. Thus, energy is saved in the skipped time interval. At time point Tₙ₊₁, the mobile terminal 20 begins to move. Thereafter, the signal quality of base stations Y and Z are measured again. The above technique of determining whether the mobile terminal 20 is moving or not by determining whether the signal quality variation is larger than the predetermined valve is not unique. Other techniques or means, for example, GPS (Global Positioning System), gyro-control, or the like are also conceived.

While the invention herein disclosed has been described by means of specific embodiments, numerous modifications and variations could be made thereto by those skilled in the art without departing from the scope and spirit of the invention set forth in the claims.

What is claimed is:

1. In a mobile communication system including at least one base station each having a mobile terminal covered therein, a method of decreasing the times of measuring a signal quality of each base station by the served mobile terminal comprising the steps of:
(a) causing the mobile terminal to receive common broadcasted information containing data about the at least one base station to be measured;
(b) causing the mobile terminal to establish a measurement table including at least one base station wherein the at least one base station is associated to at least one measurement group each having a corresponding measurement frequency;
(c) causing the mobile terminal to measure the signal quality of the at least one base station based on the measurement frequency of the associated measurement group; and
(d) adjusting the measurement group containing the at least one base station based on the measured signal quality of each one of the at least one base station and a comparison therebetween.

2. The method of claim 1, wherein the step (d) comprises the sub-steps of:
(d1) assigning the base station to the measurement group if only one base station is contained in the measurement table;
(d2) in response to the measurement table including a plurality of base stations, comparing the signal quality of one base station with that of another, sorting the compared base station, and assigning the sorted base station to one of at least one measurement group; and
(d3) setting a measurement frequency of the at least one measurement group based on the signal quality of the at least one base station in the at least one measurement group.

3. The method of claim 2, wherein in the sub-step (d3) the set measurement frequency of the at least one measurement group is a default measurement frequency.

4. The method of claim 1, wherein between the steps (a) and (b) further comprises the sub-step (a1) of, in response to detecting the mobile terminal to be motionless, setting the measurement frequency of the at least one measurement group other than the measurement group containing the base station in the measurement table as a predetermined value.

5. The method of claim 1, wherein the signal quality of the at least one base station measured by the mobile terminal is the measured signal strength added with a weight.

6. A system of decreasing the times of measuring base stations' signal quality by a served mobile terminal, the system comprising:
a communication network including at least one base station;
a covered base station within the communication network and having a service area, the covered base station being adapted to transmit common broadcasted information containing data about the at least one base station to be measured; and
a mobile terminal located in the service area of the covered base station, the mobile terminal being adapted to receive common broadcasted information, establish a measurement table including at least one of measurement group having a corresponding measurement frequency, measure a signal quality of of the at least one base station based on the measurement frequency of the associated measurement group, and adjust the measurement group containing the at least one base station based on the measured signal quality of each one of the at least one base station.

7. The system of claim 6, wherein the mobile terminal is adapted to set a measurement frequency of each one of the measurement groups based on the measured signal quality of the at least one base station.

8. The system of claim 7, wherein the set measurement frequency of the at least one measurement group by the mobile terminal is a default measurement frequency.

9. The system of claim 6, wherein the mobile terminal further comprises movement determination means for determining whether itself is moving or not.

10. The system of claim 6, wherein the mobile terminal further comprises a weight to be added to the measured signal strength of the at least one base station for creating signal quality of the at least one base station.
